(19) United States
(12) Patent Application Publication
(10) Pub. No.: US 2011/0029480 A1
(43) Pub. Date: Feb. 3, 2011

(54) Method of Compiling Multiple Data Sources into One Dataset

(75) Inventor: Joseph DeLucia, Wayside, NJ (US)

Correspondence Address: Shane Thielen, 1248 'O' Street, Suite 600, Lincoln, NE, 68508, US

(73) Assignee: IntelliCubes, Inc., Wilmington, DE (US)

(21) Appl. No.: 12/534,275

(22) Filed: Aug. 3, 2009

(51) Int. Cl. G06F 17/30

(52) U.S. Cl. 707/616; 707/E17.014; 707/E17.009

(57) ABSTRACT

A method and device is disclosed for retrieving and compiling data from multiple independent sources into a data structure that is universal for all data sources. The data structure supports multi-threaded requests to retrieve such data and is therefore highly efficient for large, heavily trafficked datasets.

### BACKGROUND AND PRIOR ART

Data storage and retrieval is a maturing field. Computer systems for storing, retrieving and combining data are known in the art. However, even with significant experience in handling data, the problem of how to handle large datasets from multiple sources efficiently has been often addressed but never solved.

Multidimensional databases are known in the art. Multidimensional databases sometimes employ a “cube” structure which allows a consumer of data to select certain dimensions of the database for comparison. This structure is efficient for viewing data which exists in one dataset, but not operative for disparate datasets.

Consumers of data often want to examine datasets that are not strictly related or linked to each other to look for significant data correlation. Other times, consumers want to examine datasets that have been stored efficiently for one purpose but which are inefficient for relating or linking to each other. Still other times, various datasets have evolved organically over the course of years to the point where it is no longer practical or even possible to relate or link them efficiently.

The prior art has addressed this issue by adding processing power and ad hoc tools to an otherwise unaltered and antiquated method of data management. Generally, when a data consumer wishes to retrieve and correlate data from various, otherwise unrelated data sources with current technology, the consumer must use a number of tools and steps. First the consumer must gain access to each data source. Usually this is done with tools provided by the manufacturers of each data storage solution, or by creating tools specifically for the purpose. Next the consumer must analyze the form in which the data from each data source is stored; with that information, the consumer can determine how the data may be related. Then the consumer would design queries to retrieve the data the consumer wants from each data source. After that the consumer would store all of the retrieve data in one local data source, presumably combining such data into one cohesive dataset in the process. Finally the consumer would access that local data source to perform whatever data analysis the consumer originally wished to perform.

In addition to being cumbersome, that process has the added disadvantages of requiring copious amounts of local storage capacity to store what is essentially a duplicative copy of all the data, and of requiring ever increasing processing power to execute queries on ever increasing datasets. Memory addressing of large datasets is a known limitation in the art. Also, the locally stored data is also segregated from each data source that provided the data to begin with, so the consumer does not have an efficient option for including any new data in his analysis.

While processing power improves geometrically, the volume of data being processed increases exponentially; therefore, the prior art methodology can never address the issue in a satisfactory way. What is needed is a method and a device for retrieving and compiling data from multiple data sources efficiently and in real time.

### SUMMARY

The present invention teaches a method and a device for retrieving and compiling data from multiple data sources efficiently and in real time. One embodiment of the method comprises the steps of executing a query against one or more data sources; organizing each resulting record from said query into a universal data structure; and storing said results in said data structure as an independent dataset. Another embodiment of the method comprises the steps of receiving data compiled from one or more data sources; storing said data in a memory storage device; and creating a data structure to represent said data stored in said memory storage device, such data structure comprising a unique key to facilitate data indexing, a pointer to a memory address representing said data in said memory storage device, and a data partition guide containing a structural definition of said data.

One embodiment of the device is a data processing system that comprises one or more interface means, each functionally connected to one data source through an application program interface; a central processing unit functionally connected to each said interface means; a data storage means functionally connected to the central processing unit; an input means functionally connected to the central processing unit; one or more registers, each intended to receive data from said data sources; a set of resources on said central processing unit to execute a query to combine said data; and one ore more memory units in the data storage means comprising at least one memory block to store a data indexing means, at least one memory block to store a data reference means, and at least one memory block to store a data organization means.

Data from multiple data sources retrieved and compiled by such methods and by such a device is retrieved faster and more efficiently, and is more readily updated than data retrieved and compiled by existing means. This technology has applications in every field of data management including online analytical processing, data mining, business performance management and other areas of analytics.

These and other features, aspects and advantages of the present invention will become better understood with regards to the following description, appended claims, and accompanying drawings.

### LIST OF FIGURES

FIG. 1 shows a flow chart of an embodiment of the invention depicting how data is compiled from various sources and showing the data structure envisioned to store said data.

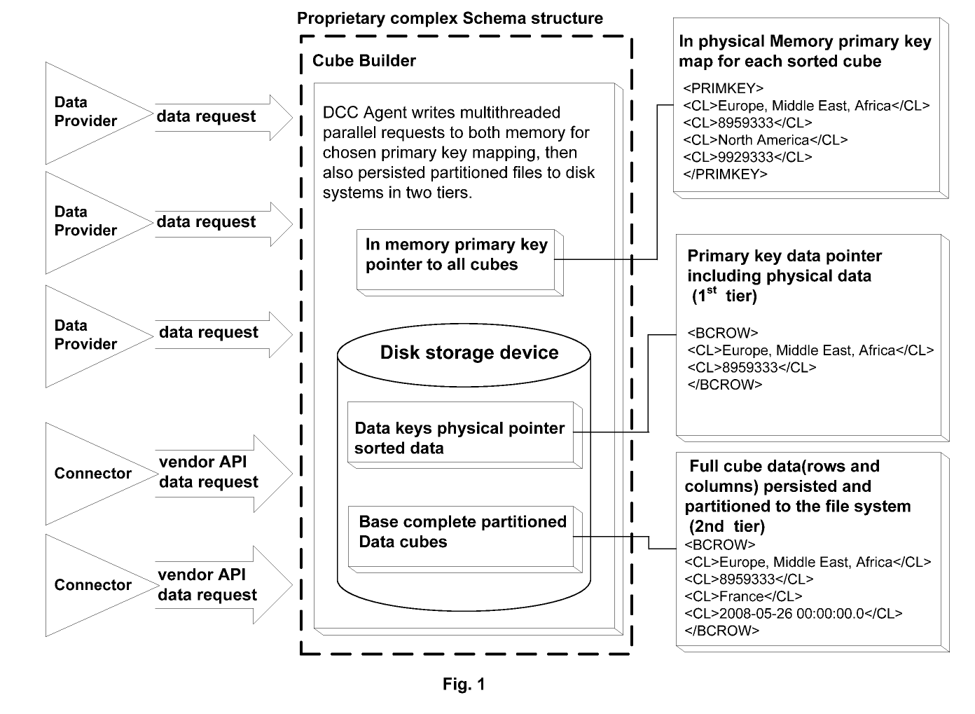

FIG. 2. shows a flow chart of an embodiment of the invention depicting how data compiled using the present invention is retrieved.

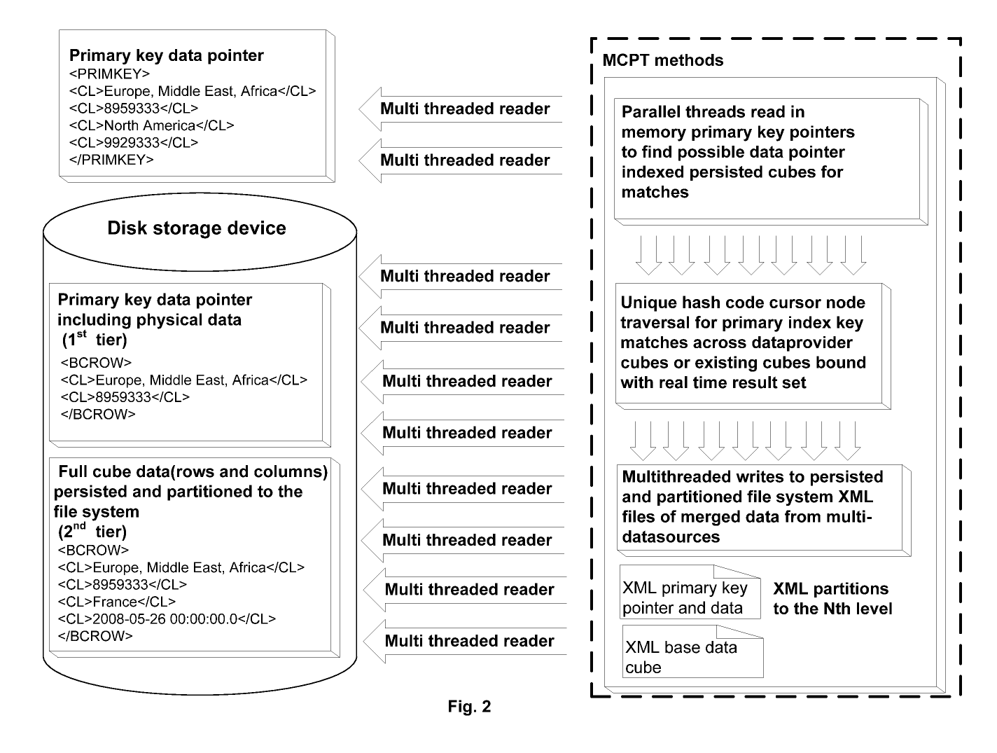

### DESCRIPTION

The present invention teaches a method, performed on a data processing system, for compiling data from one or more data sources into at least one dataset.

The data processing system comprises one or more interface means, each functionally connected to one data source through an application program interface; a central processing unit functionally connected to each said interface means; a data storage means functionally connected to the central processing unit; an input means functionally connected to the central processing unit; one or more registers, each intended to receive data from said data sources; a set of resources on said central processing unit to execute a query to combine said data; and one ore more memory units in the data storage means comprising at least one memory block to store a data indexing means, at least one memory block to store a data reference means, and at least one memory block to store a data organization means.

The method for compiling data from one or more data sources into at least one dataset comprises the steps of connecting to each data source through an application program interface; executing a query to retrieve data from each data source; organizing the resulting records from said query into a universal data structure; and storing said results in said data structure as an independent dataset.

Connecting to each data source may be accomplished by any means known in the art. The method utilized to execute a query of a data source is heavily dependent on the data source, but such methods are generally known in the art except as herein defined. The method for organizing the resulting records into a universal data structure may comprise the steps of partitioning said data into data packets; defining at least one unique key for each data packet; defining at least one pointer; storing each unique key, pointer and data packet together in a single data structure.

The data received from the query would first be partitioned based on some user limitation. Each partition would form a data packet. Each data packet would form part of a dataset. Each data packet would be assigned a unique key to identify that part of the dataset. Each data packet would also be assigned a pointer to its position in the larger dataset. Each data packet would then be stored, in memory, in a single data structure, along with its unique key and its pointer. In this way, large datasets may be broken down for efficient acess.

### Preferred Embodiment

The inventor envisions a method for compiling data from one or more data sources into at least one dataset, such method comprising the steps of connecting to each data source through an application program interface; executing a query from a single server to retrieve data from each data source; organizing each resulting record from said query into a universal data structure; and storing said results in said data structure as an independent dataset.

The step of connecting to each data source is accomplished by attaching to an application program interface through a connector. The application program interface is known in the art. Generally application program interfaces are provide with the data storage solution that stores the data. The inventor envisions that application program interfaces would be in place for each data source and does not claim application program interfaces as a feature of the invention.

The connector, through which a connection is established to the application program interface, and thereby to the data source, is a means for translating query instructions to and from each application program interface. Each connector would connect to no more than one application program interface and each application program interface would connect to no more than one connector. Each connector would be designed to function with just one type of application program interface. Queries issued to each connector are translated as appropriate and passed on to the application program interface. The application program interface then issues the queries to the data source and returns the results to the connector.

All connectors are connected to a single data processing system. The data processing system functions as a server. Users may connect to the data processing system through a client by means known in the art. The inventor specifically envisions the client as a separate data process system connecting to the server through a web based interface.

The user may then design a query that involves data from one or more of the data sources. The data processing system then interprets the query to determine what data source contains the data element sought for each data element in the query; creates one or more callable data source requests for each data source; sends each callable data source request to the appropriate data source, most likely through a connector connected to that data source; and receives data from each callable data source request.

Data is compiled and organized into a universal structure by receiving the data compiled from each data sources; partitioning the data into data packets based on size; creating a primary key to facilitate indexing of the data packet; creating a pointer to the location of the data packet in the in the larger dataset; creating a data structure to associate the primary and the pointer with the data packet; and storing the data structure in a memory storage device. The process would be repeated for each data packet produced by partitioning the data.

The data structure envisioned by the inventor is an embodiment of a multi-dimensional database. This embodiment comprises multiple three-tiered datasets. Each dataset contains a primary key which is used as an index in a hash map where said hash map stays resident in the active memory of the data processing system; a pointer to a row location in the underlying data; and the data stored in an extensible markup language (XML) format. By storing the data in an XML format, the data would contain both the data and a guide for partitioning the data into a useable format.

By these methods, very large datasets are divided into multiple smaller datasets with indexing by hash map of the galaxy of all datasets. In addition, each dataset stores its own location in the larger galaxy of datasets.

At any time, data may be updated by re-executing the query by methods previously described and integrating each resulting record from said re-execution into said independent dataset.

The inventor envisions numerous consumers submitting queries simultaneously through client connections to the data processing system. The data processing system uses multithreading to execute the queries.

The inventor has hereby disclosed a method and a device for retrieving and compiling data from multiple data sources efficiently and in real time.

The inventor claims:

1. A method for compiling data from one or more data sources into at least one dataset, such method comprising the steps of:
a) executing a query;
b) organizing the resulting records from said query into a universal data structure; and
c) storing said results in said data structure as an independent dataset.

2. The method of claim 1 where executing a query comprises the steps of:
a) determining what data source contains the data element sought for each data element in the query;
b) creating one or more callable data source requests for each data source;
c) sending each callable data source request to the appropriate data source;
d) receiving data from each callable data source request.

3. The method of claim 2 where each callable data source request is handled by an independent thread.

4. The method of claim 1 further comprising the step of executing a query to retrieve data from said independent data set.

5. The method of claim 1 further comprising the steps of:
a) re-executing said query; and
b) integrating each resulting record from said re-execution into said independent dataset.

6. A method for organizing data comprising the steps of:
a) partitioning said data into data packets;
b) defining at least one unique key for each data packet;
c) defining at least one pointer;
d) storing each unique key, pointer and data packet together in a single data structure.

7. The method of claim 6 where said data is partitioned based on some predefined limitation.

8. The method of claim 7 where the predefined limitation is based on the size of the data in bytes.

9. The method of claim 6 further comprising the step of storing each unique key as an index in a hash map.

10. The methods of claim 6 where said data packet includes a data partition guide defining the structure of said data.

11. The method of claim 6 where said pointer is a pointer to a row location in a dataset.

12. A data processing system comprising:
a) one or more interface means, each functionally connected to one data source through an application program interface;
b) a central processing unit functionally connected to each said interface means;
c) a data storage means functionally connected to the central processing unit;
d) an input means functionally connected to the central processing unit;
e) one or more registers, each intended to receive data from said data sources;
f) a set of resources on said central processing unit to execute a query to combine said data; and
g) one ore more memory units in the data storage means comprising:
i) at least one memory block to store a data indexing means;
ii) at least one memory block to store a data reference means; and
iii) at least one memory block to store a data organization means.

13. The data processing system of claim 5 where the input means comprises a separate data processing system, and said functional connection between said input means and said central processing unit is a web browser.

14. A method for searching data stored in a system of multi-dimensional databases for a desired measure or dimension, such method comprising the steps of:
a) determining one or more keys related to the desired measure or dimension;
b) executing a multithreaded search comprising the steps of:
i) instantiating an execution thread for each said key;
ii) retrieving the data packet related to each said key; and
iii) searching said data packet for the desired measure or dimension.

15. The method of claim 14 where the step of executing a multithreaded search further comprises the steps of:
a) retrieving a pointer associated with the data packet; and
b) iterating to the next data packet based on said pointer.
